(19) United States
(12) Patent Application Publication
(10) Pub. No.: US 2010/0127224 A1
(43) Pub. Date: May 27, 2010

(54) Atmospheric injection of reflective aerosol for mitigating global warming

(76) Inventor: Ryan Neff, Lincoln Park, NJ (US)

Correspondence Address: Daryl Neff, 4 Eugene Circle, Lincoln Park, NJ, 07035, US

(21) Appl. No.: 12/587,015

(22) Filed: Sep. 30, 2009

Related U.S. Application Data
(60) Provisional application No. 61/194,709, filed on Sep. 30, 2008.

(51) Int. Cl. F21V 9/04; C01B 33/12

(52) U.S. Cl. 252/587; 423/335

(57) ABSTRACT

A method is provided for mitigating global warming. In such method, fine particles can be injected or dispersed into the stratosphere. The particles can be characterized by relatively low emissivity in the visible spectrum and relatively high emissivity at thermal infrared wavelengths. In a particular embodiment, the fine particles can consist predominantly of silica. In a particular embodiment, the fine silica particles can include diatomaceous earth (DE), which may or may not be heat treated before injection and dispersal within the stratosphere. In one embodiment, the fine silica particles can include at least one of silica fume, fumed silica, or powdered quartz. The fine silica particles may have an average diameter ranging between 5 nanometers and 100 microns.

### CROSS-REFERENCE TO RELATED APPLICATION

This application claims the benefit of U.S. Provisional Application 61/194,709 filed Sep. 30, 2008 entitled “APPLICATIONS OF STRATOSPHERIC LEVEL REFLECTIVE AEROSOL DEPOSITION IN MITIGATING THE EFFECTS OF GLOBAL WARMING”, the disclosure of which is hereby incorporated by reference herein.

### BACKGROUND OF THE INVENTION

1. Field of the Invention

The present invention relates to geoengineering and more specifically to a method for mitigating global warming through injection of an aerosol such as particles into the atmosphere.

2. Description of the Related Art

The recent increase in global temperatures is changing the world's climate in unpredictable and damaging ways. No matter what the cause, whether it is because of natural factors or just simply a man-made consequence of an industrial society, the one degree Fahrenheit observed increase in global temperature has already caused incalculable damages to tropical and Arctic climates. Since 1980, the Sahara has expanded over a hundred miles. (Tucker) In summer 2007, Arctic sea ice retreated from land to its farthest extent ever; by 2020 the ice may completely disappear each summer. Tropical cyclones are becoming stronger and more frequent. In 2008, 100,000 perished from the cyclone in Myanmar. It may take a lifetime for New Orleans to recover from 2005's Hurricane Katrina. Once growing plentiful harvests, farmers are now impacted more frequently by both severe droughts and flooding.

Bleak predictions from the Intergovernmental Panel on Climate Change (IPCC) point to dangerous consequences for inaction. An estimated three to eight degree increase in mean global temperature will cause a rise in sea level that inundates and displaces hundreds of millions worldwide, melt remaining Arctic permafrost, intensify hurricane devastation, and disrupt weather patterns. (Spotts) Moreover, a relatively small change in global temperature might provoke much greater changes, known as runaway global warming, due to positive feedback events. For example, the rapid melting of Arctic sea ice wipes out reflective ice cover above ocean waters, thus increasing the ocean absorption of solar energy by the Arctic Ocean on a planetary scale. The thawing of permafrost regions releases unfathomable quantities of carbon dioxide and methane into the atmosphere and could greatly amplify global warming. (Yarris)

International agreements such as the Kyoto protocol seek to reduce man-made carbon dioxide emissions, but it is doubtful whether such measures will suffice. Scientists today suggest that only reducing fossil fuel use will not prevent catastrophic damage to global climates. (Joyce) Others warn that unless carbon dioxide is removed from the atmosphere, the warming will not stop. (Yarris) However, such a cleanup project to reclaim unfathomable amounts of carbon dioxide would be energy-demanding and almost double current energy costs. (Thambimuthu)

Recent scientific studies have demonstrated that there might be a secondary cause to global warming separate and apart from increased greenhouse gas emissions. In 2005, an article in Science cited surface observations from the Baseline Surface Radiation Network (BSRN) showing that solar radiation observed at the Earth's surface increased by 6.6 W/m−2 between 1985 and 2000. (Wild, 849) In other words, this period has been marked by “global brightening.” Since, on average, light emitted from the sun does not increase, the planetary albedo, or the overall reflectivity of the Earth, must have decreased during this period. (Wild, 848) With decreased albedo, the Earth absorbs more solar energy. Greater absorbed solar energy has caused the mean global temperature to rise rapidly since 1985.

At the same time, temperatures in the Earth's stratosphere are proven to have actually decreased between 1980 and 2000 by an unprecedented 0.7 degree Celsius. (USGCRP) It is likely that the two events are related. Lower temperatures in the stratosphere signals lower solar energy absorption there. As the stratosphere absorbs less solar energy, more solar energy reaches the Earth's surface to cause global warming. This observed correlation is a starting point for this study.

U.S. Pat. No. 5,003,186 to Chang et al. (the Chang patent) discusses a method of depositing fine particles in the stratosphere to reduce global temperatures. The Chang patent describes seeding the stratosphere with particles that have relatively low emissivity in the near-infrared spectrum and high emissivity in the far infrared and visible spectrums. “Emissivity” is a measure of how much light energy an object absorbs. Because the particles have high emissivity in the visible spectrum, the method proposed by the Chang patent could decrease the amount of visible light reaching the Earth's surface. This, in turn, would be undesirable if found to affect fundamental ecological processes such as chemical cycling, energy flow, and photosynthesis.

### SUMMARY OF THE INVENTION

According to an aspect of the invention, a method is provided for mitigating global warming. In such method, fine particles can be injected or dispersed into the stratosphere. The particles can be characterized by relatively low emissivity in the visible spectrum and relatively high emissivity at thermal infrared wavelengths.

In a particular embodiment, the fine particles can consist predominantly of silica. In a particular embodiment, the fine silica particles can include diatomaceous earth (DE), which may or may not be heat treated before injection and dispersal within the stratosphere. Heat treatment can affect the content of crystalline silica in the DE. Typically, with treatment by high heat, the DE may contain greater than 50% crystalline silica at time of the injection into the atmosphere.

In one embodiment, the fine silica particles can include at least one of silica fume, fumed silica, or powdered quartz. The fine silica particles may have an average diameter ranging between 5 nanometers and 10 microns. The fine particles may closely resemble a composition of volcanic ash, such that they have optical and physical properties similar to volcanic ash.

A method is provided for mitigating global warming in accordance with an embodiment of the invention. Such method can include injecting or dispersing fine silica particles into the stratosphere. The particles are dispersed in a concentration sufficient to cause statistically significant warming of the stratosphere. A statistically significant cooling of the troposphere can also occur simultaneously with the warming of the stratosphere.

In another embodiment of the invention, the fine silica particles may be heated so as to lower the surface area of each particle. This heating would occur in such a way as to limit the amount of surface area that the particles would add to the stratosphere. The particles would be treated so as to limit the addition of surface area available for surface-based chemical reactions, including limiting the surface area available on each particle for conversion of chlorine compounds into activated chlorine. In such way, possible effects of the particles on the ozone layer of the upper atmosphere would be limited.

In another embodiment of the invention, the fine silica particles are coated by a chemical protective layer that inhibits chemical reactions from occurring at surfaces of the particles in the stratosphere.

The fine silica particles may have an average diameter ranging between 5 nanometers and 10 microns. In a particular embodiment, the average diameter may be below 5 microns.

In a particular embodiment, the fine silica particles can include diatomaceous earth. In another embodiment, the fine silica particles include at least one of silica fume, fumed silica, or powdered quartz.

A particular embodiment provides for injecting or dispersing fine particles in the stratosphere, the particles having spectral properties similar to at least one material selected from the group consisting of sulfate aerosols or sulfuric aerosols.

### BRIEF DESCRIPTION OF THE DRAWINGS

FIG. 1 is a graph comparing the world carbon dioxide production with global sulfur dioxide emissions.

FIG. 2 is a graph of the global temperature anomaly since 1880.

FIG. 3 is a graph illustrating a transmittance, emissivity plot for sulfuric acid (H2SO4) aerosols.

FIG. 4 is a graph illustrating a transmittance plot for diatomaceous earth.

FIG. 5 is a graph overlaying a transmittance plot for sulfuric acid (H2SO4) aerosols with a transmittance plot for diatomaceous earth.

FIG. 6 is a graph showing particle distributions in atmospheric samples.

FIG. 7 is a reflectance plot for powdered quartz aerosols between 0 and 75 microns.

### DETAILED DESCRIPTION

More powerful measures may be needed than simply switching to alternative fuels to actively combat global warming without harming the environment or the economy. Herein, a geo-engineering solution is proposed for addressing the current global warming crisis. Abrupt global temperature decreases following the eruptions of Mount Saint Helens in 1980 and Mount Pinatubo in 1991 suggest that the presence of reflective aerosols in the stratosphere could reduce global warming. Different candidate aerosols are available for injection into the stratosphere which can be demonstrated to reflect visible and infrared wavelengths of light. A suitable aerosol material is in relative abundance on Earth and can be obtained relatively inexpensively and have minimal impacts on ecosystems worldwide.

An agent capable of inhibiting global warming may have already been identified and may have already been responsible for keeping global temperatures from increasing during much of the period before the present. However, the agent that may have been at work was sulfuric aerosols which are a component of air pollution. Their effect as an agent in inhibiting global warming may be lessening now. While other factors cannot be definitively ruled out, increased global warming since 1980 has occurred simultaneously with global reductions in air pollution during this period, particularly in sulfuric aerosol pollution. The atmospheric concentration of sulfuric aerosols shows a decrease of up to 50% in urban areas between 1980 and 1999, particularly in North America and Europe.

Sulfuric acid, or H2SO4, is produced when burning fossil fuels and can be found in smog, or a type of air pollution sometimes seen at lower levels of the atmosphere. Smog pollution can sometimes be found at ground level or not far above ground level in large cities or other areas where large amounts of fossil fuels are burned. Sulfuric acid is a clear liquid in dilute solutions and is tinged with yellow in concentrated solutions. When sulfuric acid is exposed to air, it makes a fine mist of sulfuric aerosols. Onions are one example where sulfuric acids can make sulfuric aerosols.

While dilute sulfuric acid is a clear liquid, sulfuric aerosols have spectral properties different from the acid itself: they absorb wavelengths of far-infrared light. Far infrared light, defined as light of wavelengths between 8 to 14 μm, is primarily responsible for thermal radiation. When far-infrared light strikes the Earth's surface, it is absorbed and converted into thermal energy which heats the Earth's atmosphere. Since sulfuric aerosols absorb far-infrared light, they prevent some of the far-infrared light from reaching the surface. Because they absorb thermal energy from far-infrared light before it can reach the Earth's surface, sulfuric aerosols also raise the temperature of the surrounding medium in accordance with the law of Conservation of Energy.

For sulfuric aerosols to decrease global temperatures, a few conditions must be met. First, the sulfuric aerosols must be present in the stratosphere, a layer of the atmosphere above the lowest atmosphere layer, the troposphere, so that the absorbed solar energy can be directed away from the surface. Already, sulfuric aerosols emitted by volcanoes and fossil fuels collect in the troposphere, but some amount makes its way to the stratosphere. Second, the sulfuric aerosols must be relatively abundant in order to absorb enough thermal energy to make a difference.

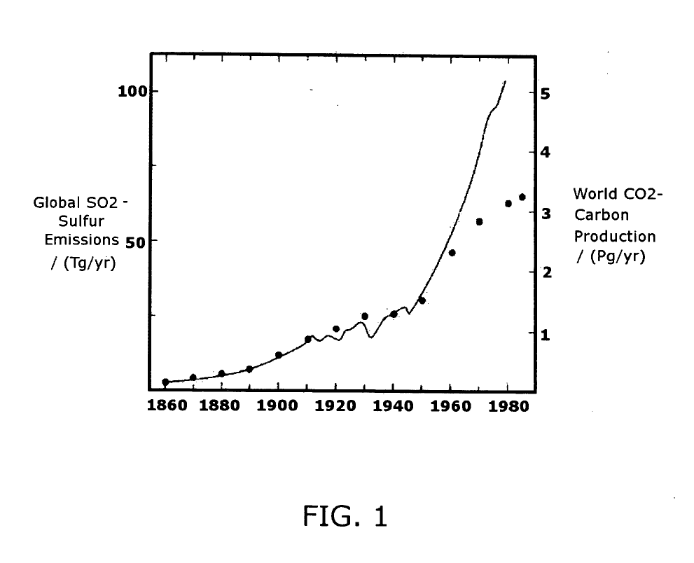

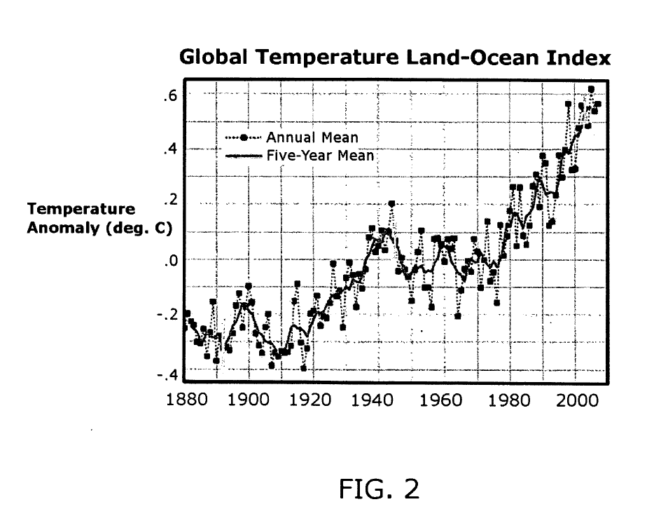

By this process, sulfuric aerosols are capable of increasing planetary albedo by absorbing far-infrared energy in the stratosphere and reradiating it back into space. The lack of a significant global temperature rise in the sulfur-laden atmosphere prior to 1980 suggests that the injection of sulfuric aerosols into the stratosphere could mitigate the effects of global warming. FIG. 1 shows that sulfur dioxide production stayed at close to a 1:1 ratio with carbon dioxide production until about 1980, when the ratio of carbon dioxide to sulfur dioxide increased. FIG. 2 shows that global temperatures remained close to long-term average (such average being indicated at 0.0° C. on the vertical scale) until about 1980, when the global temperature began to rise steadily and rapidly. One interpretation of the data would lend to the conclusion that sulfur dioxide production before 1980 shielded the earth from global warming, and that the reduction in sulfur emissions relative to carbon emissions led to an increase in the global temperature above the average. This would suggest that climate change correction would entail simply the addition of sulfur dioxide, in large quantities, to the atmosphere. However, harmful impacts upon environmental and human health from sulfuric aerosols caution against their purposeful injection into the atmosphere for mitigating global warming. Furthermore, a more precise, controlled injection of particles that can initiate global cooling can be performed with effects 100 times or more above than the cooling effects of untargeted sulfur dioxide emissions.

By simulating an atmosphere similar to that of Earth, experimentation demonstrates that the dispersion of certain types of particles could cause a change in mean atmospheric temperatures. Silica is a type of material which has been identified as a candidate for injection into the atmosphere to decrease global albedo, and hence, reduce global warming.

Silica is among the most common minerals on Earth. Silica, an oxide of silicon, is commonly found in sand and glass. Silica is also found naturally in very small particles in form of diatomaceous earth (DE). DE earth includes fossilized remains of diatoms, a type of hard-shelled algae. Particles can range from 1 to 100 microns in width. As found in nature, diatomaceous earth contains mostly amorphous silica. Amorphous silica is an efficient absorber of liquids, and for this reason, can be used as a drying agent. In some cases, DE can be obtained in which the average particle width is less than or equal to about 10 microns. When treated by high heat in a “calcining” process, DE can become mostly crystalline in form, having a crystalline content of greater than 50%, and typically 60% or more. Heat treated DE is commonly used as a water filtering agent. Among other silicates which can have fine particles are fumed silica, silica fume, and powdered quartz. Silica has spectral properties close to those of sulfuric aerosols, which, in previous abundance, appear to have inhibited global warming. Silica particles, including diatomaceous earth, have particle sizes which are capable of remaining suspended in the atmosphere for a number of years without causing noticeable environmental impact.

NASA studies following the June 1991 eruption of Mt. Pinatubo observed a global temperature decrease of 0.6 degrees Celsius (one degree Fahrenheit) between 1991 and 1992. (Ritchie, 178) The eruption involved a massive injection of volcanic ash in the atmosphere. A common component of volcanic ash, silica aerosols, are microscopic (usually having particles from 0.01 to 10 microns in diameter). The eruption may have provided sufficient energy to inject fine silica aerosols into the stratosphere. The fine silica aerosols included particles having a size small enough to be suspended by stratospheric winds for an extended period of time. Thus, the injection of fine silica aerosols into the stratosphere may be the reason for the global cooling event following the eruption.

The possibility of reversing global temperature increases by stratospheric injection of fine particles having spectral properties similar to sulfuric aerosols can be demonstrated. Silica, such as fumed silica, silica fume, powdered quartz, or diatomaceous earth, among others, can have the correct properties. Such materials are extremely fine powders that are in relative abundance on Earth. Silica absorbs the same frequencies of light as sulfuric aerosols do.

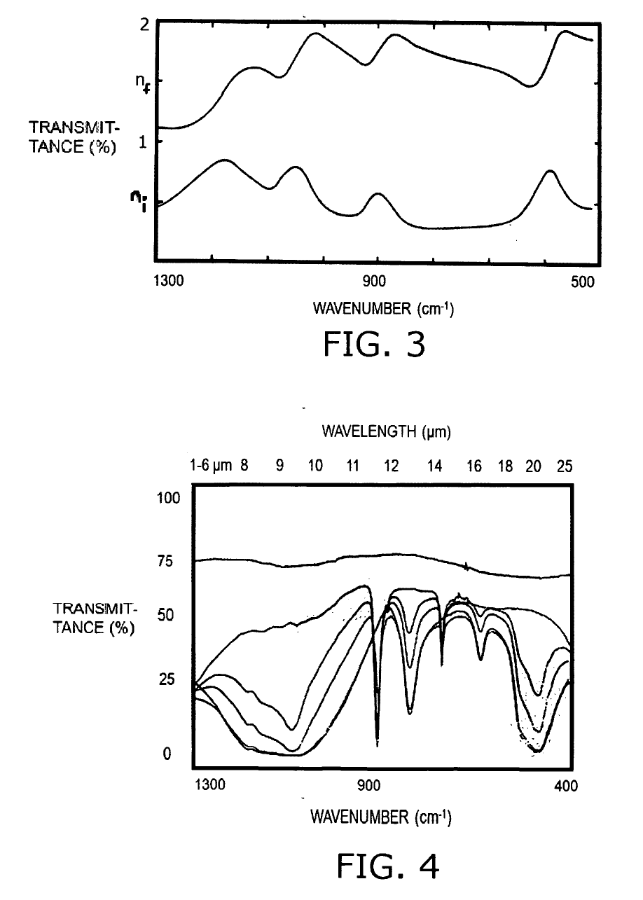

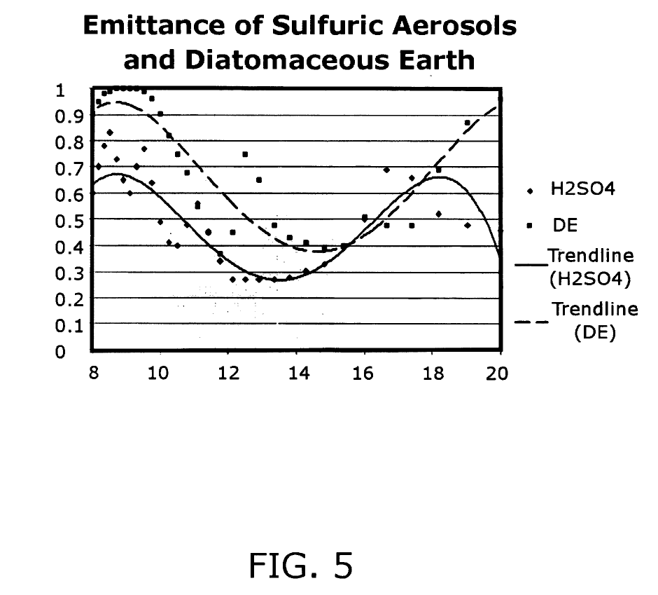

FIGS. 3 and 4 are plots of transmittance for each of sulfuric acid (H2SO4) and DE. Each shows similar thermal emissivity. As demonstrated by a combination of the data from each plot (FIG. 5) it is clear that H2SO4 aerosols and diatomaceous earth (a form of silica) have similar emissivity in the thermal range. FIG. 5 shows an emittance plot of 75% H2SO4 in Aerosol Solution and Diatomaceous Earth comparing the far-infrared wavelength (8 to 20 μm) to the total emittance (or absorption). Emittance is a measure of how much light energy an object absorbs. DE exhibits properties very similar to sulfuric aerosols in the far-infrared range: for instance, both have relatively high emittance near 9 μm and low emittance near 14 μm. Data shown on FIGS. 3, 4 and 5 are found in external references: De Freitas, and NASA Astrophysics.

This means that silica aerosols can be used to mimic the cooling effects of sulfuric aerosols in the stratosphere. Silica aerosols such as DE can also increase cloud albedo by acting as a nucleation site for water droplet formation. By increasing cloud albedo, more solar energy will be radiated into space. Finally, silica aerosols such as DE do not react with many naturally-occurring chemicals and do not break down when exposed to UV radiation. Since silica aerosols are made up of tiny particles of silicon dioxide, the aerosol is indistinguishable with sand when it falls back to the Earth.

Silica aerosols have relatively low emissivities in the visible and near infrared spectrum and comparable emissivity in the far infrared spectrum to sulfate aerosols. Therefore, silica aerosols could be used to remove “thermal” far infrared light in a targeted way to cause global cooling without substantially impacting the amount of visible light that reaches the surface of the Earth.

U.S. Provisional Application 61/194,709, incorporated by reference herein, demonstrates that a suspension of DE in a medium can decrease a rate at which a surface disposed below the medium warms in response to light of visible and thermal wavelengths. The experimental work demonstrates with confidence that diatomaceous earth can cause a decrease in mean surface temperatures for time periods equal to and beyond the testing period. In light of this demonstration, silica aerosols, when dispersed in sufficient quantity into the stratosphere can be expected to cause demonstrable and significant change in mean global surface temperature of the Earth.

These silica aerosols, like the sulfuric aerosols, added significant surface area to the stratosphere, which was seen dramatically during the volcanic eruption of Mt. Pinatubo in 1991. Sulfuric aerosols along with fine particulate volcanic ash added reaction sites for the conversion of inactivated chlorine compounds into activated chlorine. This activated chlorine, usually in the form of a free radical, can break down ozone (O₃) into diatomic oxygen and free oxygen ions. The breakdown of the ozone layer caused by this type of a reaction in undesirable because of its effects in shielding the Earth's surface from harmful ultraviolet radiation that exists in outer space and the upper atmosphere. The ozone layer is one of the most protected areas of the Earth's atmosphere as it filters all incoming solar radiation and removes harmful UV light which can harm both plants and animals alike. This UV radiation is also particularly harmful to humans and can cause cancer and in rare cases birth defects.

To help avoid unwanted effects of stratospheric particles on the ozone layer two methods are proposed. One possibility is to heat the particles before injection to a temperature just high enough to reshape the particles by smoothing out rough or jagged pockets at the surface of each particle where reactions can take place. In one embodiment, the process could be conducted in the presence of a dopant such as boron, which might further assist in lowering the glass transition temperature of the particle composition, and possibly helping to smooth the shape of the resulting particles. For example, a “boronating” process could be conducted. The process could be conducted in a way that makes the particles more spherical and standardized, and possibly even more standardize in size. In that way, the amount of surface area added by the particles to the stratosphere could be closely measured and monitored.

Another possibility is that fine silica particles could be used together with a chemical inhibitor which inhibits reaction with ozone. For example, a chemical inhibitor such as calcium hydroxide or calcium oxide could be mixed with or applied to particles prior to their dispersal in the atmosphere. Such inhibitors can include, which can combine with free, activated chlorine to make harmless compounds that are trapped within the particle or which return to the surface, such as in form of rain water. The size of the particle has a direct effect on the residence time of the particle in the stratosphere. “Residence time” is traditionally defined as the amount of time a small aerosol particle can stay aloft in the atmosphere and is usually measured by observing the concentration of the particle in the atmosphere after a number of days, months, or years have elapsed. For the particles to have a desired effect in mitigating global warming, the residence time of particles should be sufficiently long to provide stable long-term residence in the stratosphere. However, the residence time should not be too great, in order to allow for up or down adjustment of the cooling effect in trending towards or maintaining a desired long-term result. With a desired residence time, the particle concentration could be allowed to decrease so that, in times of uncontrolled global cooling events, such as volcanic eruptions and natural variations in solar output, the climate effects of these natural events would be reduced.

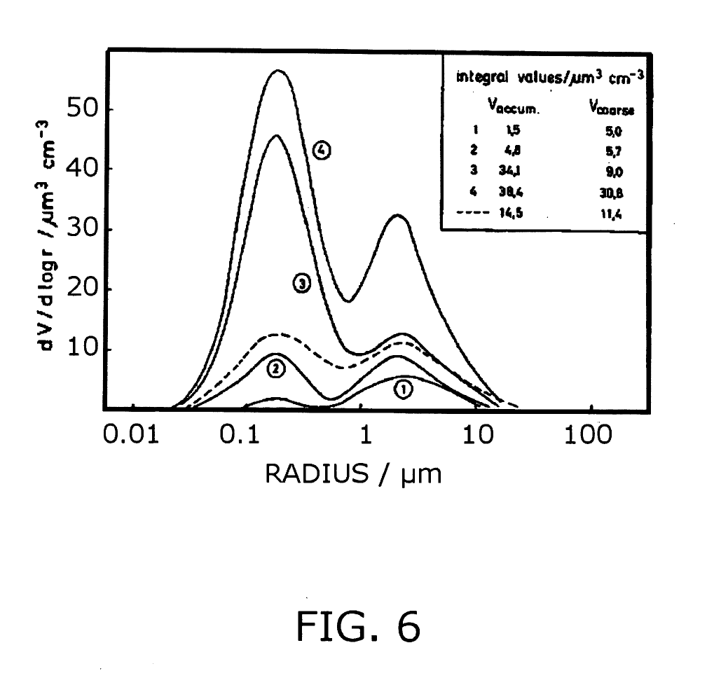

Particles with different sizes have different residence times because of their specific gravity, a measure of their mass against their surface area. Particles with low surface area and high mass have lower residence times than particles with high surface area and low mass. Another factor to consider when engineering residence time is the particle's ability to condense into larger particles. For instance, particles under 0.05 microns typically stick together in the atmosphere and create larger particles that can then fall out of the atmosphere at a higher rate. FIG. 6 is a graphing showing distributions of particle sizes as measured in four different samples conducted at different atmospheric locations. Curves labeled 1 and 2 show the particle distributions at locations far from emissions of particle matter. The curves labeled 3 and 4 show the particle distributions at locations near sources of particle emissions The curves demonstrate that particles can be found which persist in the atmosphere which range between 0.01 microns and 100 microns in size, and which are more commonly seen between about 0.02 microns and 20 microns, as represented on the logarithmic scale of FIG. 6. From the figure, it is apparent that particles having sizes near 0.2 microns or near 4 microns are in greatest abundance in each of the distributions found in the atmospheric samples. This may indicate that particles of these sizes tend to persist in the atmosphere for relatively long periods of time. Thus, it may be desirable to inject particles having these sizes into the stratosphere to achieve a desirable residence time. Therefore, the particles could have sizes mostly between about 0.2 microns and about 10 microns, or be even more closely distributed with most particles having sizes between about 0.5 microns and about 5 microns. It might even be beneficial to engineer silica particles to have average particle size near 0.2 and 4 microns.

Another factor that could be considered when engineering the particles is the particles' relative abilities to effloresce and deliquesce. Efflorescence is defined as a material's ability to lose water traditionally in its crystalline form at certain temperatures and pressures. Deliquescence is the compounds ability to absorb water into its crystalline structure at certain temperatures and pressures. It may be beneficial to use a type of silica or diatomaceous earth that has efflorescent and deliquescent properties similar to volcanic aerosols, so as to more closely mimic a global cooling effect that has been observed after volcanic eruptions. It is possible that deliquescent particles are a source of cloud condensation nuclei (CCN) which can contribute to the formation of clouds in the stratosphere. Thus, the silica particles might function as CCNs to provide surfaces on which water vapor molecules condense and form clouds in the stratosphere. The formation of stratospheric clouds may provide an additional way to reflect some incoming sunlight before it reaches the lower atmosphere and, thus, help mitigate the warming effect caused by greenhouse gases.

Alternatively, in a particular embodiment, particles could be selected which effloresce readily but which do not deliquesce or do not deliquesce much. Using such particles, one could deliberately limit the effect of the particles on the formation of stratospheric clouds. This could be one way of controlling or reducing the formation of stratospheric clouds so as to control or limit the reduction in visible light to the Earth's surface.

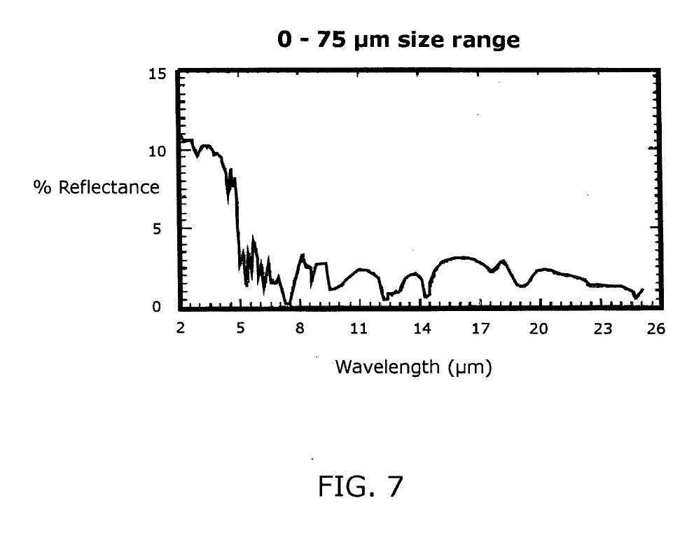

Silica aerosols can be injected into the stratosphere using a variety of means. Silica particles in form of DE, fumed silica, silica fume, powdered quartz or other material could be injected into the atmosphere during the fuel combustion and exhaust production processes of high-flying aircraft. FIG. 7 is a graph illustrating reflectance for powdered quartz. For example, without limitation, the aerosol could be provided as an additive to a combustion or after-combustion process of an aircraft engine in flights entering the stratosphere (typically at altitudes above 35,000 feet). Alternatively, separate from a combustion process, the aerosol could be metered out through dedicated equipment therefore.

The process may be controlled so as to inject the aerosol when the aircraft is at a location within the atmosphere that leads to dispersion of a large amount of the aerosol in the stratosphere. The process may also be controlled so as to not disperse the aerosol when the aircraft is at a location that leads to dispersion of a large amount of the aerosol in the troposphere. The altitudes at which the aerosol injection can be performed can vary with latitude, seasonal weather patterns, and even local weather patterns and weather events. The site of particle injection can be selected in accordance with latitude as well. A greater amount of sunlight typically reaches the Earth at low latitudes. Therefore, aerosol injection into the stratosphere at low latitudes (tropical and subtropical) can be expected to directly block a greater amount of sunlight than at middle latitudes and at high latitudes beyond the Arctic and Antarctic Circles. However, aerosol injection in the middle and high latitudes might also help mitigate global warming, for example, if it caused the rate at which ice and snow melts to decrease due to decreased warming from sunlight. In that case, more snow and ice would remain available at the middle and higher latitudes to reflect sunlight back into space. The same effect could also occur if the dispersal of the silica aerosol were to increase the rate of snow and ice accumulation in the middle and higher latitudes.

Other possible ways of injecting silica aerosols into the stratosphere include launching of high-altitude balloons carrying the particles and equipment for dispersing the particles into the surrounding air. Rockets might also be used to carry the particles into the stratosphere. There may be still other ways in which silica aerosols can be injected into the atmosphere.

From the foregoing it is demonstrated that silica aerosols including diatomaceous earth can be a global warming inhibitor when dispersed into the stratosphere in sufficient quantities. The magnitude of a decrease can mitigate the effects of global warming while the aerosol remains present in the stratosphere.

While the invention has been described in accordance with certain preferred embodiments thereof, those skilled in the art will understand the many modifications and enhancements which can be made thereto without departing from the true scope and spirit of the invention, which is limited only by the claims appended below.

1. A method of mitigating global warming comprising injecting fine particles in the stratosphere, the particles characterized by relatively low emissivity in the visible spectrum and relatively high emissivity at thermal infrared wavelengths.

2. A method as claimed in claim 1, wherein the fine particles consist predominantly of silica.

3. A method as claimed in claim 1, wherein the fine silica particles include diatomaceous earth.

4. A method as claimed in claim 3, wherein the diatomaceous earth contains greater than 50% crystalline silica at time of the injection into the atmosphere.

5. A method as claimed in claim 1, wherein the fine silica particles include at least one of silica fume, fumed silica, or powdered quartz.

6. A method as claimed in claim 1, wherein the fine silica particles have average diameter ranging between 0.01 and 10 microns.

7. A method as claimed in claim 1, wherein the composition of the fine particles closely resembles a composition of volcanic ash.

8. A method as claimed in claim 1, wherein the particles are designed in such a way that the particle size maximizes their residence time aloft in the stratosphere.

9. A method as claimed in claim 1, wherein the particles have average sizes of 0.2 microns and 4 microns.

10. A method as claimed in claim 1, wherein the composition of the fine particles closely resembles a composition of volcanic ash injected into the stratosphere by the 1991 eruption of Mount Pinatubo, Philippines.

11. A method of mitigating global warming comprising dispersing fine silica particles in the stratosphere.

12. A method as claimed in claim 1, wherein the particles are dispersed in a concentration sufficient to cause statistically significant warming of the stratosphere and statistically significant cooling of the troposphere simultaneous with the warming of the stratosphere.

13. A method as claimed in claim 11, wherein the fine silica particles include diatomaceous earth.

14. A method as claimed in claim 11, wherein the fine silica particles are heated as to lower their surface area.

15. A method as claimed in claim 11, wherein the fine silica particles are coated by a chemical protective layer that inhibits chemical reactions along the surface of each particle in the stratosphere.

16. A method as claimed in claim 15, wherein the chemical protective layer includes at least one of calcium hydroxide or calcium oxide.

17. A method as claimed in claim 11, wherein the fine silica particles include at least one of silica fume, fumed silica, or powdered quartz.

18. A method as claimed in claim 11, wherein the fine silica particles have average diameter ranging between 0.01 microns and 10 microns.

19. A method as claimed in claim 11, wherein the fine silica particles are treated so that they can effloresce readily and have no more than low deliquescence, such that the particles inhibit the formation of cloud condensation nuclei.

20. (canceled)

21. A method of mitigating global warming comprising dispersing fine particles in the stratosphere, the particles having spectral properties similar to at least one material selected from the group consisting of sulfate aerosols or sulfuric aerosols.

22. A method as claimed in claim 2, wherein the particles are dispersed in a concentration sufficient to cause statistically significant warming of the stratosphere and statistically significant cooling of the troposphere simultaneous with the warming of the stratosphere.

23. A method as claimed in claim 3, wherein the particles are dispersed in a concentration sufficient to cause statistically significant warming of the stratosphere and statistically significant cooling of the troposphere simultaneous with the warming of the stratosphere.

24. A method as claimed in claim 4, wherein the particles are dispersed in a concentration sufficient to cause statistically significant warming of the stratosphere and statistically significant cooling of the troposphere simultaneous with the warming of the stratosphere.

25. A method as claimed in claim 5, wherein the particles are dispersed in a concentration sufficient to cause statistically significant warming of the stratosphere and statistically significant cooling of the troposphere simultaneous with the warming of the stratosphere.

26. A method as claimed in claim 6, wherein the particles are dispersed in a concentration sufficient to cause statistically significant warming of the stratosphere and statistically significant cooling of the troposphere simultaneous with the warming of the stratosphere.

27. A method as claimed in claim 7, wherein the particles are dispersed in a concentration sufficient to cause statistically significant warming of the stratosphere and statistically significant cooling of the troposphere simultaneous with the warming of the stratosphere.

28. A method as claimed in claim 8, wherein the particles are dispersed in a concentration sufficient to cause statistically significant warming of the stratosphere and statistically significant cooling of the troposphere simultaneous with the warming of the stratosphere.

29. A method as claimed in claim 9, wherein the particles are dispersed in a concentration sufficient to cause statistically significant warming of the stratosphere and statistically significant cooling of the troposphere simultaneous with the warming of the stratosphere.

30. A method as claimed in claim 10, wherein the particles are dispersed in a concentration sufficient to cause statistically significant warming of the stratosphere and statistically significant cooling of the troposphere simultaneous with the warming of the stratosphere.

31. A method as claimed in claim 11, wherein the particles are dispersed in a concentration sufficient to cause statistically significant warming of the stratosphere and statistically significant cooling of the troposphere simultaneous with the warming of the stratosphere.
